(19) United States
(12) Patent Application Publication
(10) Pub. No.: US 2009/0303522 A1
(43) Pub. Date: Dec. 10, 2009

(54) SYSTEMS AND METHODS FOR SELECTIVELY PRINTING USING A NETWORKED PRINTER

(76) Inventor: Shane R. Konsella, Boise, ID (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/253,153

(22) Filed: Oct. 16, 2008

Related U.S. Application Data
(60) Provisional application No. 61/131,684, filed on Jun. 10, 2008.

(51) Int. Cl. G06F 15/00

(52) U.S. Cl. 358/1.15

(57) ABSTRACT

The present disclosure is directed to selective printing of a print job based on the printing capabilities of a networked printer. Print jobs can be sent to a print server and sorted based on various printing requirements. The print jobs can then be sent to printers capable of printing the print characteristics.

### BACKGROUND OF THE INVENTION

Many forms of printing have been developed that utilize a variety of printing materials, including numerous inks, toners, printing substrates, and other specialty materials. Many of these printing materials are configured for use on a particular type of printing device, such as an ink-jet or a laser printer. Additionally, certain printing materials may be designed for use in printing a particular print job. For example, certain inks may be designed specifically for printing photographic images. Often, materials that are designed for a specific task are more expensive to use than normal printing materials, and as such, can represent a significant waste of resources when used in normal printing jobs.

One specific example of such a specialty material includes magnetic ink character recognition (MICR) ink or toner. MICR printing is widely used in the financial and banking industries to facilitate the processing of checks. Numbers or symbols printed with a MICR system can be read quickly and accurately by a MICR reader to allow automated check or other document processing. In addition to check and document scanning, MICR printing has also been used as a security mechanism to verify the authenticity of a check or other document. MICR ink or toner often contains an iron oxide to produce a magnetically detectable signature corresponding to the font or symbol shapes. Due to their specialized nature, MICR inks and toners tend to be more expensive to use. Additionally, in some cases MICR inks and toners may be use restricted for security reasons.

One problem that arises when using MICR inks and toners occurs when a print job is sent to a printer server, and subsequently an attempt is made to print the print job on a connected printer. If the printer does not contain the appropriate ink or toner, the resulting document will be printed with normal printing materials and thus will fail authentication and/or sorting. Attempts to solve this problem have included using a print data analyzer in the printing device to analyze incoming data from the print job to determine if MICR printing is necessary. If such printing is necessary, the received portion of the print job may be discarded or the user may be prompted to replace the ink or toner cartridge, thus requiring that the printer be taken offline. In the former case, the user may have no way of knowing why a print failure occurred, and may attempt to reprint the document. The latter case is problematic because a user may have no way of knowing whether the prompt is related to their print job, particularly in situations where there are numerous individuals utilizing the same print server and/or printer.

### BRIEF DESCRIPTION OF THE DRAWINGS

FIG. 1 depicts a system for selectively printing a print job in accordance with one embodiment of the present disclosure; and

FIG. 2 depicts an alternative system for selectively printing a print job in accordance with another embodiment of the present disclosure.

### DETAILED DESCRIPTION OF THE PREFERRED EMBODIMENT(S)

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

In describing and claiming the present invention, the following terminology will be used in accordance with the definitions set forth below.

It is noted that, as used herein, the singular forms of “a,” “an,” and “the” include plural referents unless the context clearly dictates otherwise. Thus, for example, reference to “a document” includes one or more of such documents, reference to “an amount of toner” includes reference to one or more amounts of toners, and reference to “the printer” includes reference to one or more printers.

As used herein, the term “print image” may be used to refer to any symbol or marking that is printed or intended to be printed, including, but not limited to a font, a picture, a symbolic design, a pixel, combinations thereof, etc. Thus a MICR print image is a print image that is, or is intended to be, printed with a MICR toner or ink.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The present invention is directed to methods and systems for selectively printing a print job on a printer that is capable of printing the print job using the intended print materials. Print jobs may be sorted into print categories that correspond to specific printing requirements, and thus time and resources may be saved by printing print jobs on printers specifically intended for a particular print category. For example, photographic quality print jobs can be flagged and printed on a photo printer, while black and white text print jobs can be flagged and printed on a black and white laser printer. Such sorting and flagging thus ensures that black and white text print jobs are not printed on a more costly photo printer, and conversely, photographic quality print jobs are not printed on a black and white printer. The same can be said for distinguishing a MICR print job which can be sorted or separated from a non-MICR print job at the server, for example.

A variety of print categories are contemplated based on various inks, toners, and printing media. For example, in certain aspects, the print category may include, without limitation, magnetic ink character recognition (MICR), non-MICR, color, black and white, photographic, color graphic, specialty paper, regular paper, combinations thereof, etc. While sorting based on print categories is useful in a variety of situations, it is particularly useful in the area of MICR printing. MICR inks and toners are relatively expensive, and thus it is wasteful to print non-MICR print jobs on a MICR enabled printer. Conversely, printing a MICR print job on a non-MICR printer will not allow recognition of the printing in a MICR reader. Possibly more seriously, a document or check may not be recognized as authentic in those situations where MICR printing is used for security verification purposes.

Accordingly, in one aspect, a method of selectively printing a print job is provided. Such a method can include sending a print job to a print server, assigning a print category to the print job at the print server based on characteristics of the print job, and enabling printing of the print job only on a printer that is in communication with the print server and that is authorized to print based on the print category. The method can further include printing the print job on a printer that is authorized to print based on the print category.

A print job can first be sent from a computer to a network print server. The print job can be communicated to the print server by a variety of well known means, including wired or, wireless, e.g., 802.11 or IR, connections. In some aspects, the print job can be flagged for printing on any networked printer that is capable of printing the print job. In other aspects, the print job can be flagged for printing on a selected printer that is capable of printing the print job. In such cases, a user can manually select the print job from the print queue at the printer to initiate printing. This latter situation may be useful in situations where increased security measures are taken, such as in printing checks or confidential documents.

Once the print job has been sent to the print server, sorting logic at the server level analyzes the print job to determine its particular print characteristics. Such analysis may be accomplished by parsing the print job for printing instructions indicative of a particular type of printing. The sorting logic is thus capable of determining any printing requirements that are present in a print job that may require sorting to specific printers. The print job is subsequently flagged accordingly with a corresponding print category. For example, if the sorting logic determines that the print job contains a MICR print image, the print job will be flagged within a MICR print category. Alternatively, the server could flag all non-MICR print jobs and leave the MICR print jobs unflagged. Furthermore, a print job could be flagged as a photo print job, a non-photo print job, a black and white print job, a full color print job, a print job with some other type of specialty ink, etc. A print job may be flagged with a single print category, or it may be flagged with multiple print categories. For example, certain print jobs may contain both color and MICR printing. Such a print job can thus be flagged with both color and MICR print categories to be printed on a printer capable of printing both color and MICR. Additionally, it should be noted that in one aspect the print job could be analyzed and flagged by the same or similar sorting logic. In another aspect, the print job could be analyzed by the sorting logic and flagged by a separate flagging logic.

Following flagging, the print job is enabled with respect to a printer on which the print job can be printed. The factors determining whether a printer is capable of printing a print job in a particular print category can include physical limitations of a printer currently loaded ink or toner, currently loaded paper type, combinations thereof, etc. The printer capability is most likely determined at the level of the printer. For example, a sensor in the printer can determine whether or not a particular toner or ink is present. In the case of MICR printing, sensor logic in the printer can determine whether a MICR toner or ink cartridge is present. Similarly, the printer can analyze paper in the paper tray to determine if a particular specialty paper is present. Alternatively, one or more of these properties can be manually entered into the computer or server system to which it is attached.

Enabling the print job can occur by a variety of techniques. For example, in one aspect enabling printing of a print job can include identifying the print category the printer is capable of printing, and pulling the print job from the print server by the printer, where the print job corresponds to the print category the printer is capable of printing. In this case, a pull-print logic that recognizes that a print job can be printed on a particular printer is located at the printer. In other words, once the pull-print logic determines the printer's print category capabilities, the pull-print logic queries the print server for print jobs that match that print category. One or more print jobs can then be pulled from the print server to the printer to be printed. It should be noted that the print category capabilities of the printer can be determined by the pull-print logic or they can be determined by a separate logic and communicated to the pull-print logic.

In another aspect of the present disclosure, enabling printing of a print job can include identifying the print category the printer is capable of printing, and sending the print job from the print server to the printer, where the print job corresponds to the print category the printer is capable of printing. In this case, authorization logic can be located at the server level that can determine the printer's print capabilities and authorize a particular print job to be printed on a particular printer. Authorized print jobs can then be sent from the server to the printer to be printed. The printer can thus identify to the print server what print categories the printer is capable of printing, and the print server can send one or more print jobs matching that category to the printer. The print job(s) sent to the printer may include a specific print job or jobs requested by a user, or it may include print job(s) that merely match the print category capability of the printer that need to be printed. It should be noted that the print job can be communicated from the print server to the printer by a variety of well known means, including wired, wireless, and infrared connections.

As a more specific example, in one aspect, a method of selectively printing a print job can include sending a print job to a print server, querying the print job at the print server to determine if a MICR print image is associated with the print job, establishing a print category of the print job based on the query for the MICR print image, and enabling printing capability of the print job only on printers authorized to print based on the print category. In such a case, only print jobs including a MICR print image can be printed on a printer using MICR toner or ink. As such, in one specific aspect, enabling printing capability can further include determining that the print job contains the MICR print image, flagging the print job to allow the print job to only be printed on a printer that is authorized to print the MICR print image, and flagging the print job to not allow the print job to be printed on a printer that is not authorized to print the MICR print image. This procedure thus insures that print jobs containing MICR print images are printed on a MICR capable printer.

It is also contemplated that print jobs lacking a MICR print image may be excluded from printers utilizing MICR toner or ink. In one specific aspect, enabling printing capability can thus further include determining that the print job does not contain the MICR print image, and flagging the print job to not allow the print job to be printed with MICR toner. Such a print job can thus be flagged such that the print job cannot be printed on a printer that contains MICR toner, or the print job can be flagged such that the print job can be printed on a printer that does not contain MICR toner. Precluding printing of a non-MICR print job on a MICR enabled printer thus limits the use the more expensive MICR inks and toners for print jobs that actually contain information for printing MICR print images. However, in some cases it may be more productive to print a non-MICR print job on a MICR enabled printer. Such cases may arise when all non-MICR printers are either in use or are offline. It may thus be beneficial to override the sorting and allow a non-MICR print job to be printed on a MICR enabled printer. In one aspect, for example, the method may include identifying an authorized override instruction, and flagging the print job to allow the print job to be printed with MICR toner.

Enabling a MICR or other category of print job can occur by a variety of techniques. For example, in one aspect enabling printing of a print job can include identifying that the printer is capable of MICR printing, and pulling a MICR print job from the print server by the printer. In this case a pull-print logic that recognizes a MICR print job is located at the printer. In other words, once the pull-print logic determines that the printer is MICR enabled, the pull-print logic queries the print server for MICR print jobs. One or more print jobs can then pulled from the print server to the printer to be printed. It should be noted that the print category capabilities of the printer can be determined by the pull-print logic or they can be determined by a separate logic and communicated to the pull-print logic.

In another aspect of the present disclosure, enabling printing of a print job can include identifying whether or not the printer can print with MICR toner or ink, and sending a MICR print job from the print server to the printer. In one aspect, an authorization logic is located at the server level that can determine whether or not the printer can MICR print, and can authorize a particular print job to be printed on a particular printer. Authorized print jobs can then be sent from the server to the printer to be printed. In one specific aspect, the printer can identify to the print server that the printer is capable of MICR printing, and the print server can send one or more MICR print jobs to the printer. The print job(s) sent to the printer may include a specific print job or jobs requested by a user, or it may include print job(s) that merely match the print category capability of the printer that need to be printed. It should be noted that the print job can be communicated from the print server to the printer by a variety of well known means, including wired, wireless, and infrared connections.

In another aspect of the present invention, a “user-driven” approach is contemplated. In such a situation, a user can approach a printing device in order to print a previously queued print job. The print jobs resident on the print server will have been flagged as has been described above. The user with thus be presented with only those print job that are available to be printed on that particular printer. In one aspect, this may be accomplished by displaying all of the print jobs resident on the print server and “graying out” those that are unavailable for printing on the printer. In another aspect, the printer may only display those print jobs that are available for printing on the printer. Thus the print job sorting and flagging operations function to provide the user with only those print jobs that are capable of being printed on the particular printer the user is using.

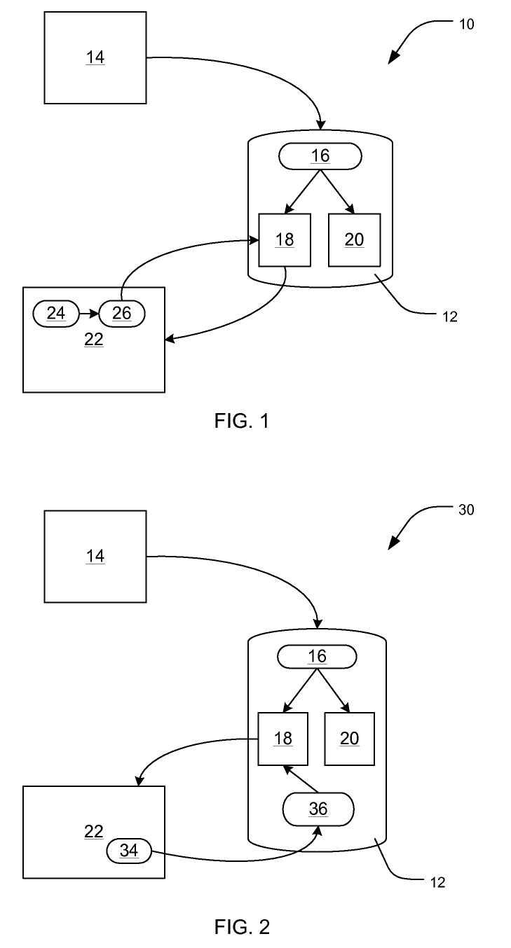

The present invention additionally provides systems for selectively printing a print job. In one aspect, as is shown in FIG. 1, a system 10 for selectively printing a print job can include a print server 12 capable of receiving a print job from a computer or computer terminal 14, a sorting logic system 16 associated with the print server, where the sorting logic is configured to query the print job to determine if a MICR print image is associated with the print job, and a flagging system (not shown) associated with the print server, where the flagging system is configured to sort print jobs having an associated MICR print image 18 from print jobs that do not have an associated MICR print image 20. Additionally, the system can include a printer 22 operatively coupled to the print server, and a printer type logic system 24 associated with the printer, where the printer type logic system is configured to determine a print category that the printer is authorized to print. For example, if the printer contains MICR toner, the printer type logic system will determine that the print category of the printer is MICR. In one aspect, the printer may also include a pull-print logic 26 configured to query the print server for a flagged print job that the printer is authorized to print and to pull the flagged print job to the printer. Thus the printer type logic system informs the pull-print logic of the printing capabilities of the printer, and the pull-print logic system identifies and pulls print jobs having the same print category requirements to the printer. FIG. 1 shows a MICR print job being pulled from the server. In those cases where the printer does not contain MICR toner or ink, the pull-print logic could pull a non-MICR print job (not shown).

In another aspect, as is shown in FIG. 2, a system 30 for selectively printing a print job can include a print server 12 capable of receiving a print job from a computer or computer terminal 14, a sorting logic system 16 associated with the print server, where the sorting logic is configured to query the print job to determine if a MICR print image is associated with the print job, and a flagging system (not shown) associated with the print server, where the flagging system is configured to sort print jobs having an associated MICR print image 18 from print jobs that do not have an associated MICR print image 20. Additionally, the system can include a printer 22 operatively coupled to the print server, and a printer type logic system 34 associated with the printer, where the printer type logic system is configured to determine a print category that the printer is authorized to print. For example, if the printer contains MICR toner, the printer type logic system will determine that the print category of the printer is MICR. In one aspect, an authorization logic 36 configured to receive the print category from the printer type logic system can be associated with the printer server. Thus the authorization logic can receive the print category that the printer is capable of printing, and identify a flagged print job on the print server matching the print category. The flagged print job is then sent from the print server to the printer to be printed. FIG. 2 shows a MICR print job being sent from the print server to the printer. In those cases where the printer does not contain MICR toner or ink, the authorization logic could identify and initiate sending a non-MICR print job to the printer (not shown).

While the invention has been described with reference to certain preferred embodiments, those skilled in the art will appreciate that various modifications, changes, omissions, and substitutions can be made without departing from the spirit of the invention. It is therefore intended that the invention be limited only by the scope of the appended claims.

What is claimed is:

1. A method of selectively printing a print job, comprising:
sending a print job to a print server;
assigning a print category to the print job at the print server based on characteristics of the print job; and
enabling printing of the print job only on a printer that is in communication with the print server and that is authorized to print based on the print category.

2. The method of claim 1, further comprising printing the print job on a printer that is authorized to print based on the print category.

3. The method of claim 1, wherein the print category is a member selected from the group consisting of MICR, non-MICR, color, black and white, photographic, color graphic, specialty paper, and combinations thereof.

4. The method of claim 1, wherein the print category is MICR.

5. The method of claim 1, wherein enabling printing of the print job further comprises:
identifying the print category the printer is capable of printing; and
pulling the print job from the print server by the printer, wherein the print job corresponds to the print category the printer is capable of printing.

6. The method of claim 1, wherein enabling printing of the print job further comprises:
identifying the print category the printer is capable of printing; and
sending the print job from the print server to the printer, wherein the print job corresponds to the print category the printer is capable of printing.

7. A method of selectively printing a print job, comprising:
sending a print job to a print server;
querying the print job at the print server to determine if a MICR print image is associated with the print job;
establishing a print category of the print job based on the query for the MICR print image; and
enabling printing capability of the print job only on printers authorized to print based on the print category.

8. The method of claim 7, wherein enabling printing capability further includes:
determining that the print job contains the MICR print image;
flagging the print job to allow the print job to only be printed on a printer that is authorized to print the MICR print image; and
flagging the print job to not allow the print job to be printed on a printer that is not authorized to print the MICR print image.

9. The method of claim 7, wherein enabling printing capability further includes:
determining that the print job does not contain the MICR print image; and
flagging the print job to not allow the print job to be printed with MICR toner.

10. The method of claim 9, further comprising flagging the print job to allow the print job to be printed on a printer that does not utilize MICR toner.

11. The method of claim 9, further comprising:
identifying an authorized override instruction; and
flagging the print job to allow the print job to be printed with MICR toner.

12. The method of claim 7, further comprising printing the print job on a printer that is authorized to print based on the print category.

13. The method of claim 7, wherein enabling printing of the print job further comprises:
identifying the print category the printer is capable of printing; and
pulling the print job from the print server by the printer, wherein the print job corresponds to the print category the printer is capable of printing.

14. The method of claim 7, wherein enabling printing of the print job further comprises:
identifying the print category the printer is capable of printing; and
sending the print job from the print server to the printer, wherein the print job corresponds to the print category the printer is capable of printing.

15. A system for selectively printing a print job, comprising:
a print server capable of receiving a print job;
a sorting logic system associated with the print server, said sorting logic being configured to query the print job to determine if a MICR print image is associated with the print job;
a flagging system associated with the print server, said flagging system being configured to sort print jobs having an associated MICR print image from print jobs that do not have an associated MICR print image;
a printer operatively coupled to the print server; and
a printer type logic system associated with the printer, said printer type logic system being configured to determine a print category that the printer is authorized to print.

16. The system of claim 15, further comprising an authorization logic associated with the print server, said authorization logic being configured to authorize printing of a flagged print job on a printer authorized to print the MICR print image.

17. The system of claim 15, further comprising a pull-print logic associated with the printer, said pull-print logic being configured to query the print server for a flagged print job that the printer is authorized to print and to pull the flagged print job to the printer.
